(19) United States
(12) Patent Application Publication
(10) Pub. No.: US 2023/0348680 A1
(43) Pub. Date: Nov. 2, 2023

(54) UV PROTECTION FILM FOR OUTDOOR USE

(71) Applicant: RENOLIT SE, Worms (DE)

(72) Inventors: Friedrich-Wilhelm STRUVE, Rosenheim (DE); David SAGERER, Mannheim (DE); Martin ROESSLE, Mainz (DE)

(73) Assignee: RENOLIT SE, Worms (DE)

(21) Appl. No.: 18/192,419

(22) Filed: Mar. 29, 2023

Related U.S. Application Data
(63) Continuation-in-part of application No. PCT/EP2021/078028, filed on Oct. 11, 2021.

(30) Foreign Application Priority Data
Oct. 12, 2020 (DE) 102020126708.8
Dec. 1, 2020 (DE) 102020131858.8
Mar. 31, 2022 (DE) 102022107719.5
Mar. 31, 2022 (DE) 102022107720.9

(51) Int. Cl. C09D 175/04; C08J 5/18

(52) U.S. Cl. CPC C08J 5/18; C09D 175/04; C08J 2333/08

(57) ABSTRACT

A UV protective film comprising a base film of PVC, polyacrylate or polyolefin, a printed design, an abrasion resistant polyurethane based hot melt coating, and a lacquer or a polymer protective layer, a method for manufacturing coated construction elements by laminating the UV protective film to a substrate, use of the UV protective film for coating substrates and a process for the production of UV protective films, in which a base film from PVC, polyacrylate or polyolefin is printed with a design, a polyurethane based hot melt coating is applied and a lacquer and/or a polymer protective layer is applied thereover, wherein a layer below the lacquer is embossed.

### CROSS-REFERENCE TO RELATED PATENT APPLICATIONS

This application is a Continuation-In-Part of co-pending International Application No. PCT/EP2021/078028 filed on Oct. 11, 2021, which is based upon and claims the benefit of priority from prior German Patent Applications Nos. DE102020126708.8 filed Oct. 12, 2020 and DE102020131858.8filed Dec. 1, 2020, and claims the benefit of priority from prior German Patent Applications Nos. DE102022107720.9 filed Mar. 31, 2022 and DE102022107719.5 filed Mar. 31, 2022, the entire contents of all of which are incorporated herein by reference in their entirety.

### FIELD OF INVENTION

The present invention relates to UV protective films for outdoor use, especially for coating construction elements such as floor coverings, in particular terrace tiles or terrace slabs and screed, which are intended for outdoor use and to their manufacturing.

### BACKGROUND

An important trend in recent years has been to create valuable-looking construction elements for outdoor use. More and more people are designing terraces, balconies and outdoor seating areas as additional “living space”. In addition to appropriate furniture, this also includes homey floor coverings, visual protection elements, fences, plant boxes and much more. Although the look of natural stone and wood is largely preferred, easier-to-clean surfaces are required.

These requirements can be met by plastics. In addition to the use of solid plastics, more recently also so-called WPC materials (wood plastic composite), it has long been known to coat substrates. This has also been very successful for elements such as walls or fences. In the case of floor coverings, however, the durability has so far been insufficient and/or there have been other shortcomings. For example, the laminating films known from furniture and floor panels for indoor use have the problem in outdoor use, among others, that decorative papers fade due to a lack of UV protection by the upper layer(s) and the surface is often too smooth, so that the slip resistance required for outdoor floors is not achieved.

Thus, the object remains to provide low-maintenance and durable surfaces with a desired appearance for outdoor use.

### SUMMARY

Surprisingly, it has now been found that printed base films made of PVC, polyacrylate or polyolefin, which are provided with an abrasion resistant polyurethane based hot melt coating and are optionally lacquered, exhibit effective UV protection and thus the necessary durability of the printed design is achieved. Slip resistance is ensured by structuring or embossing in combination with the abrasion resistant PUR hot melt coating. In a preferred variant, the structuring or embossing is particularly easy to obtain by means of an embossed intermediate layer underneath the PUR hot melt coating. In a further preferred embodiment the structuring is achieved particularly efficiently by applying a layer by means of rollers, one of which is structured.

The above problem is thus solved by a UV protective film which comprises:
a base film, in one variant an at least 500 µm thick base film, of PVC, polyacrylate or polyolefin,
a printed design and/or colouring of the base film,
an abrasion resistant polyurethane based hot melt coating, and
a lacquer and/or a polymer protective layer.

The problem is also solved by a method for the manufacturing of UV protective films, in which a base film of PVC, polyacrylate or polyolefin, which is printed with a design and/or is colored, is provided, optionally an intermediate layer of a first reactive polyurethane based hot melt coating is applied above the base film, a layer of an abrasion-resistant, second polyurethane based hot melt coating is applied, and above the base film or, as the case may be, above the intermediate layer, a lacquer and/or a polymer protective layer is applied, wherein the abrasion-resistant, second polyurethane based hot melt coating or the intermediate layer or the lacquer or two or all three of them are applied by a pair of rollers with a structured roller and provided with a structure by the structured roller. Furthermore, the problem is solved by a method for manufacturing of coated construction elements, in which this UV protective film is laminated to a substrate, preferably glued to floor slabs or a floor made of concrete or screed, by the use of the UV protective film for coating substrates and by a process for the production of UV protective films, in which a base film, in one variant an at least 500 µm thick base film, made of PVC, polyacrylate or polyolefin is printed with a design and/or colored, a polyurethane based hot melt coating and, on top of this, a lacquer and/or a polymer protective layer are applied, wherein one layer underneath the lacquer is embossed.

### BRIEF DESCRIPTION OF THE DRAWINGS

FIGS. 1 to 9 depict embodiments of a method for manufacturing a UV protective film according to the present application.

FIGS. 10 depicts an embodiment showing the layers of a first preferred UV protective film separated and brought together.

FIGS. 11 depicts an embodiment showing the layers of a second preferred UV protective film separated and brought together.

FIGS. 12 depicts an embodiment showing the layers of a third preferred UV protective film separated and brought together.

### DETAILED DESCRIPTION

The UV protective films according to the invention have an at least three-layer, preferably a four-layer, structure. Further layers are possible, e.g. a primer on the underside of the base film. The layers of the UV protective film can each consist of several layers independently of each other. For example, thick layers can be obtained by repeated coating with a doctor blade of the material or a base film can be produced by coextrusion. The layers may have identical or different compositions.

In the context of the present invention, bottom, below, underside, etc. means the surface of a layer facing or closer to the substrate. Top, above and upper side designates a layer facing away from or further away from the substrate, the uppermost surface of the UV protective film forming the use surface of the construction element.

The bottom layer is a printable base film. On the one hand, this must provide sufficient adhesion to the substrate during lamination, and on the other hand, it gives the UV protective film the necessary mechanical properties as a carrier during manufacture and processing.

Suitable materials for the base film are PVC (polyvinyl chloride), polyacrylates and polyolefins. Either as such, or at least with additives known per se, these have good UV stability. They are also very resistant to hydrolysis and thermolysis.

The bond to the substrate is usually achieved by adhesive lamination, e.g. by means of a polyurethane hot melt adhesive, reactive polyolefin hot melt or reactive silane-terminated hot melt. To optimise adhesion, the base film can be provided with a primer on the underside. For example, a primer based on vinyl chloride-vinyl acetate copolymer is well suited for PVC, polyacrylate and PVC-polyacrylate films. For polyolefin films, a 2-component polyurethane primer is suitable, among others. The base film can alternatively or additionally be subjected to a plasma or corona treatment or other surface treatment.

A PVC base film preferably contains, in addition to the polyvinyl chloride, a stabiliser, processing aids, UV absorbers, an antistatic agent and pigments. Preferably, modifiers, especially polyacrylate, and epoxidised soybean oil are also included. Tin has proved particularly useful as a stabiliser; BaZn and CaZn are also useful. Tin is preferably used in combination with phosphite as a costabiliser. Processing aids are, for example, polymeric flow aids, e.g. based on MMA, BA, styrene. In addition, PVC films with polymer plasticisers and with copolymers - in particular based on vinyl chloride and acrylates - can be used.

The PVC content is typically 70 wt.% to 85 wt.%. The plasticiser content is typically up to 30 wt.%, but can be fully or partially replaced by suitable raw material supplements or alternative raw materials such as copolymers. One component in the formulation can be recycled material. The amount can be set to up to 20 wt.-%, preferably up to 5 wt.-%. The material introduced may be of the same or slightly different formulation.

Polyacrylate base films may preferably be made from methyl methacrylate (MMA), butyl acrylate (BA) and/or ethyl acrylate (EA), in particular copolymers of two, more preferably all three of said monomers, are used. The base film also usually contains one or more UV absorbers, e.g. based on benzotriazole, antioxidants such as phenolic antioxidants, light stabilisers, preferably HALS, and pigments. In addition, polyacrylate based processing aids may be included.

Polyolefin base films may preferably be made from polyethylene, polypropylene or olefin copolymers. Here, olefins means in one variant hydrocarbons with at least one aliphatic C-C double bond, i.e. linear and cyclic alkenes, which can carry hydrocarbon substituents. Substituents with other groups, such as acid and ester groups, are not included. The films may contain filler, e.g. chalk, and the usual additives. For example, per 100 parts by weight of polyolefin or polyolefin alloy, preferably propylene homo-polymer or high density polyethylene (HDPE), the polyolefin base film may contain 25 to 120 parts by weight of a finely divided mineral filler or mineral filler mixture, preferably calcium carbonate, alkaline earth oxides, microtalcum, kaolin, silicates, magnesium aluminium oxy- or hydroxy-carbonates and/or silicates and/or silica gel with an average grain diameter below 10 µm, preferably from 0.05 to 5 µm. According to another embodiment, the polyolefin base film contains, per 100 parts by weight of polyolefin or polyolefin alloy, preferably propylene homopolymer or HDPE, from 5 to 40 parts by weight (based on 100 parts by weight of polyolefin), preferably from 10 to 30 parts by weight, of at least one finely divided organic filler or combinations of these amounts by weight of organic fillers with from 0 to 30 parts by weight, preferably from 5 to 25 parts by weight, of at least one finely divided mineral inorganic filler or filler mixture. In a further, preferred embodiment, the base film contains 50 to 80 wt.-% of polypropylene, preferably light-stabilized, 5 to 20 wt.-% of HDPE, preferably light-stabilized, 1 to 5 wt.-% of antioxidants, 1 to 5 wt.-% of processing aids and 5 to 15 wt.-% of anti-blocking additives and, if desired, coloring additives.

The thickness of the base film is typically from 80 to 250 µm, preferably from 100 to 200 µm, and most preferred from 120 to 160 µm. In one variant the thickness of the base film is from 500 to 2500 µm, preferably from 1000 to 2000 µm. The base film is usually produced by calendering, but may also be extruded. Extrusion includes all processes, namely blown film extrusion, casted film and cast film extrusion. Casted film extrusion is preferred. The melt is distributed through a slot die and cooled by a cooling roll/chill roll. Single-screw and multi-screw extruders and variations thereof are possible as tools. Preferably, the production is carried out with a single-screw extruder. The base film can be stretched uni- or bi-directionally. This provides a higher dimensional stability against the temperatures during the application of the melt coating. In addition, the risk of microcracks in the melt coating is minimised when substrates are wrapped with the UV protective film according to the invention. By stretching, the stretchability of the base film adapts to that of the hot melt coating, i.e. it becomes similarly low.

The desired design is printed on the base film, unless the base film is dyed for solid colours. The base film can be dyed through or, in the case of multi-layer base films, the top layer can be dyed through. This is preferred for plain designs. A base colour can also be provided for printing by a solid-coloured base film or top layer of the base film. Design printing can be achieved in any known manner. Particularly useful are, for example, gravure printing, especially with solvent inks, and digital printing. Wood decor, natural stone and fantasy patterns are possible as well as plain colours. The printing ink is applied to the base film by a series of printing rollers, for example. In digital printing, both single-pass and multi-pass print heads can be used for design. The printed images are often composed of several printing inks and are characterised by light stability. In addition to solvent based inks, aqueous based inks are also possible.

The pigments used to colour the base film or its uppermost layer and to create solid colours can be organic or inorganic and reflect or transmit the IR component in sunlight.

An abrasion resistant polyurethane based hot melt coating is applied on top of the print. In the context of the present invention, polyurethane based hot melt coating, also referred to as PUR hot melt coating or hot melt coating for short, means a reactive hot melt mass as described, for example, in WO 2006/056472 A1, WO 2012/084823 A1, WO 2006/106143 A1 or US 8,153,265 B2. The reactive hot melt mass can react and cure e.g. by the humidity of the environment, but also by irradiation with e.g. UV light. It can be a one- or two-component mass. It is important that it is a transparent PUR hot melt coating so that the colour or print remains visible through the hot melt coating.

Preferably, one-component reactive hot melt masses that are cured by atmospheric humidity and contain a polyurethane prepolymer are used. When heated, the prepolymer chains liquefy to form an applicable liquid that cures to form a polyurethane layer when moisture is added.

To increase the abrasion resistance, the reactive hot melt mass of the abrasion resistant hot melt coating contains particles with a corresponding hardness. Preferred are particles used as abrasive like corundum, zirconium, silicon carbide, boron nitride, diamond or glass particles. In particular, corundum and glass particles are preferred due to their cost-effectiveness.

The abrasion resistant PUR hot melt coating layer normally has a thickness of 10 to 150 µm, preferably of 20 to 120 µm and in particular of 30 to 100 µm. It can be applied in a manner known per se by brushing on, coating on with a doctor blade, roller application, etc. In one preferred embodiment, the application is carried out with a pair of rollers in which one roller is structured.

In a preferred embodiment, a smooth or structured or embossed intermediate layer is arranged under the PUR hot melt coating, which is also formed from a polyurethane based reactive hot melt mass, but contains no filler or considerably less filler than the PUR hot melt coating. The intermediate layer must also be transparent. The intermediate layer makes it particularly easy to obtain the entire PUR hot melt coating free of bubbles and thus highly transparent. Without a filler-free intermediate layer, gas bubbles can be introduced during the application of the PUR hot melt coating, which impair the transparency.

The thickness of the intermediate layer depends on the desired embossing depth or depth of the structuring and the thickness of the abrasion resistant PUR hot melt coating layer and is usually from 10 to 100 µm, preferably from 20 to 80 µm, particularly preferably 30 to 60 µm.

The application of the intermediate layer can be carried out in the same way as the application of the abrasion resistant PUR hot melt coating, wherein the same or different processes can be used for the coatings of one film. In a preferred embodiment, the intermediate layer is applied by means of a slot die, with or without a roller bar, and the PUR hot melt coating layer is applied by means of roller application, wherein preferably one of the rollers is structured. It is expedient to use the same reactive hot melt mass for the intermediate layer as for the PUR hot melt coating, but without particles. It is also possible to use a different reactive hot melt mass, e.g. a radiation-curable mass for the intermediate layer and a moisture-curing mass for the hot melt coating. The intermediate layer can also be provided as a film, e.g. an embossed film. The intermediate layer significantly improves the UV protection as it contains no or few particles. Without the intermediate layer, particles in the PUR hot melt coating could reach the base film and thus transmit light directly to the printed design.

If no structured or embossed intermediate layer made of a polyurethane based reactive hot melt mass is provided, either the base film or preferably the PUR hot melt coating layer is structured or embossed. The structuring or embossing of the base film and/or the intermediate layer and/or the PUR hot melt coating is carried out in a manner known per se, e.g. by embossing with a pair of rollers or by application with a pair of rollers in which one roller is structured. As is also known, the structuring or embossing pattern can be matched to and correspond with the print design. For example, it is common for a structuring or embossing to follow the grain of the printed wood structure or to simulate joints in a tile look.

Typical depths of the structuring or embossing depths, respectively, are from 5 to 30 µm, preferably from 10 to 20 µm. This, in combination with the particles in the PUR hot melt coating layer, ensures sufficient slip resistance. Usually, slip resistance values of at least R10 to R12 according to DIN 51130 or ASR A1.5/1.2 are achieved, preferably at least R11. However, the embossing depths or depths of the structuring, respectively, can also be considerably deeper, e.g. 60 µm or even more, if the design lets it seem desirable.

The upper layer is formed by a transparent lacquer and/or a peelable polymer protective layer. The film is very rough on the surface due to the abrasion resistant PUR hot melt coating layer. This is also desired to achieve a high slip resistance when wet. However, a very rough and very hard abrasion resistant surface has the disadvantage that the pressure rollers of wrapping or coating machines wear out in a very short time and the process becomes unstable. Complaints due to faulty coating are the consequence. Therefore, the surface of the protective film according to the invention is formed by the lacquer or the polymer protective layer. The application of a lacquer or a polymer protective layer is also necessary in order to be able to immediately wind up the film with the PUR hot melt coating. Otherwise the film roll will block, as it normally takes some time for the applied hot melt coating(s) to cure block-proof. If the protective polymer layer does not build up too much adhesion to the PUR hot melt mass, the lacquer layer can be omitted, the material can be wound up because of the protective layer. An additional advantage of the protective layer is that it protects the surface of the constructiion element against scratching, e.g. by the abrasion resistant PUR hot melt coating of other construction elements. A lacquer remains part of the protective film according to the invention, the polymer protective layer is peeled off after production of the construction element or directly before or after its laying/installation.

Acrylic lacquers and polyurethane lacquers are preferred as lacquer, especially radiation-curable lacquers. Preferably, the lacquer is cross-linked by UV or LED lamps. This can be done by a single or multiple sources. Herein, the energy output is e.g. 30 W to 200 W, preferably 50 W to 180 W, in particular 90 W to 150 W.

The lacquer is applied by roller or spray application and, if necessary, cured by irradiation. Thicknesses from 1 to 50 µm, preferably from 3 to 15 µm, particularly preferred from 5 to 10 µm, have proven effective. On the one hand, the lacquer improves the UV protection, on the other hand, it provides an anti-blocking effect so that the UV protective film can be wound on and, above all, unwound without any problems. The lacquer normally has a low gloss level of 4 to 20 gloss points, preferably up to 15 gloss points, according to ISO 2813. The measurement is made using a goniophometer. The angle of measurement can be 20°, 35°, 60° (preferred) and 80° or 85°. The lacquer can in one variant provide the only structuring of the film and is then applied with a pair of rollers in which one roller is structured. If the lacquer provides the structuring, correspondingly thick lacquer layers are selected which allow the desired structuring depth, e.g. of 5 to 30 µm and also of 60 µm or more.

A hot melt mass of polyethylene (PE, preferably HDPE) or of PE (preferably LDPE mixed with linear low density polyethylene, LLDPE) and ethylene vinyl acetate (EVA) is preferably used as the polymer protective layer. EVA typically has a vinyl acetate content in the range of 15 to 25 wt.-%. The polymer protective layer may contain additives such as thermal stabilisers, HALS, UV stabilisers and possibly fillers. In a preferred embodiment, no additives are contained or only UV stabilisers in a lower than usual amount.

The material of the polymer protective layer shows a desired adhesion to the PUR hot melt mass layer or the lacquer by choosing the right weight ratio of PE to EVA. The adhesion should be sufficient that the polymer protective layer does not peel off significantly until the completion of the construction element production. It must be low enough to allow the protective layer to be peeled off. The mixing ratios depend on the set surface roughness and, if necessary, also on the desired adhesion to the lacquer. The mixing ratio PE:EVA, related to the mass, can be from 1:5 to 5:1, preferably from 1:1 to 3:1, depending on the desired adhesion. The adhesion can also be influenced by mixing different PE, for example, an admixture of LLDPE leads to increased adhesion and at the same time improved tear resistance, which facilitates peeling. Other melting masses that build up the desired adhesion with the PUR melt coating layer or the lacquer are also possible, e.g. masses that are known as protection for PVC-laminated sheets.

The polymer protective layer can be applied to the rough surface after the PUR hot melt coating or after lacquering using a cast coating process, doctor blade process or rolling process. The casting process into a cooled roller nip is preferred. In this process, the molten mass runs into the valleys and defuses the abrasive effect. The side facing the sheathing pressure rollers is preferably smooth.

The amount applied depends on the structure of the slip-resistant PUR hot melt coating and ranges from 20 g/m² to 200 g/m², preferably from 100 g/m² and 150 g/m².

The total thickness of the UV protective film without polymer protective layer is usually from 10 to 150 µm, preferably from 40 to 100 µm and more preferred from 50 to 80 µm. In the variant with an at least 500 µm thick base layer the total thickness of the UV protective film without polymer protective layer is from 550 to 3000 µm, preferably from 600 to 2100 µm and more preferred from 1500 to 2000 µm.

Preferably, the UV protective film according to the invention has at least one of the following properties:
scratch resistance ≥ 3 N, preferably ≥ 4 N, according to DIN 15186, or at least class A3 according to DIN EN 16094:2012-04 and B3 according to DIN CEN/TS 16611:2014, and/or
abrasion and wear resistance ≥ 3,000 revolutions, preferably ≥ 4,000 revolutions according to DIN EN 13329, or ≥ 8,000 revolutions, preferably 10,000 revolutions according to EN 14354:2017-11, and/or
weather resistance with at least 10,000, preferably at least 15,000, test hours according to EN 513 (method 1 (M)) and thereby a minimum colour stability of grey scale 3, assessed according to EN 20105-A02 and/or
slip resistance reaches at least class R10, which according to DIN 51130:2014 corresponds to a minimum slope of 10°, preferably R11.

Suitable substrates are wood, metal, plastic and composite materials, in one variant especially WPC and fiber composites, and in particular concrete and screed. The substrate provides the necessary mechanical properties for the construction element. The coating with the UV protective film provides the desired optical design on the one hand and protects the substrate from the weather on the other. Plastics do not age due to UV light, metals do not corrode, wood and concrete as well as screed remains dry and is also protected from UV light. The surface is easy to clean and thus remains visually appealing for much longer and with much less effort.

Typical construction elements are floor boards and slabs for terraces, balconies, paths, etc., panels, fence posts and fence elements, visual protection elements, and plant boxes. According to the invention, floor coverings are of particular interest, as they have high slip resistance requirements, get dirty particularly quickly and are subject to high UV and mechanical stress. Previous products often failed to achieve slip resistance, deteriorated too quickly in appearance due to UV light and/or were not able to withstand the mechanical stresses. Delamination, especially at corners and edges, occurred frequently.

In contrast, the construction elements made according to the invention have improved UV protection, especially when the intermediate layer is present, and do not have to make any compromises in terms of slip resistance. The mechanical load-bearing capacity is also improved, since the adhesion of the base film to the substrate and of the film layers to each other is optimal due to the measures described.

For substrates made of composites such as WPC and fiber composite, it is possible to improve adhesion by giving them a core-shell structure. Here, a core with a higher amount of filler (wood or fibers) is enclosed or covered by a layer with less to no filler. The adhesion of films and other decor supports to the outer layer of plastic with little or no filler is substantially improved.

Well-known films for outdoor use are, for example, the Elesgo paper based film. In this film, a printed paper film impregnated with acrylate is coated with a thick acrylic lacquer containing corundum. The top structure is created by a texturing film, whereby only slip resistance in the range of R10 can be achieved. This is a low value for safe walking on in wet conditions. Variants of this plastic based film with improved internal strength have the same negative slip behaviour due to the identical manufacturing technology of the coating. The process is shown at https://laminate.de/index.php/de/technologie2/prozess.

Furthermore, HPL compact plates are known, which are produced on the basis of melamine or phenolic resin impregnated papers. Many of these products have a low light resistance due to the printing. The slip resistance of these products is created via press plates, which reduces the effectiveness of interspersed corundum in the top paper layer. Although this achieves good abrasion resistance, the slip resistance is rather low because the press plates would otherwise be quickly worn out due to the process.

The current state of the art does not know any high-quality decors in the horizontal outdoor area, as they can be implemented with this invention. Existing systems fail after only a few years due to the high demands. Known failures are separation of the layers, breakage of the layers, fading and change of colour due to the use of unsuitable UV-protective layers, difficult process control due to too high stiffness, favouring of water absorption and resulting swelling capacity, lack of adhesion to the substrate.

Furthermore, the UV protective films according to the invention are suitable for the decorative design of swimming pool covers (so-called roller shutter system). Previously known plastic films have often failed due to their lack of weathering stability. In the case of plastic films with a transparent polyacrylate layer as weather protection, clouding thereof due to water absorption is a problem. The UV protection films according to the invention, on the other hand, offer good stability in chlorinated (and also saline) swimming pool water as well as the necessary weathering stability. The known shutter-like covers are suitable as substrates with the condition that the cover must be buoyant. Thus, segments made of wood, plastic and composite materials are preferred, and in the case of the particularly preferred hollow segments, those made of plastic, composite materials and metal.

As an alternative to a base film, a high pressure laminate (HPL) or continuous pressure laminate (CPL), as well as impregnated paper finish films and glass fiber films can also be provided as decor supports with a two-layer protection from an intermediate layer and an abrasion resistant hot melt coating, which are covered with lacquer and/or a polymer protective layer. Such decor supports are common, for example, in facade panels, and are generally much thinner than 500 µm. Such decorative substrates also benefit from the additional intermediate layer as protection against weathering. Since the intermediate layer contains no or few particles, damage due to UV radiation conducted through particles to the print is prevented, as already mentioned. In addition, moisture penetration along the particles is blocked.

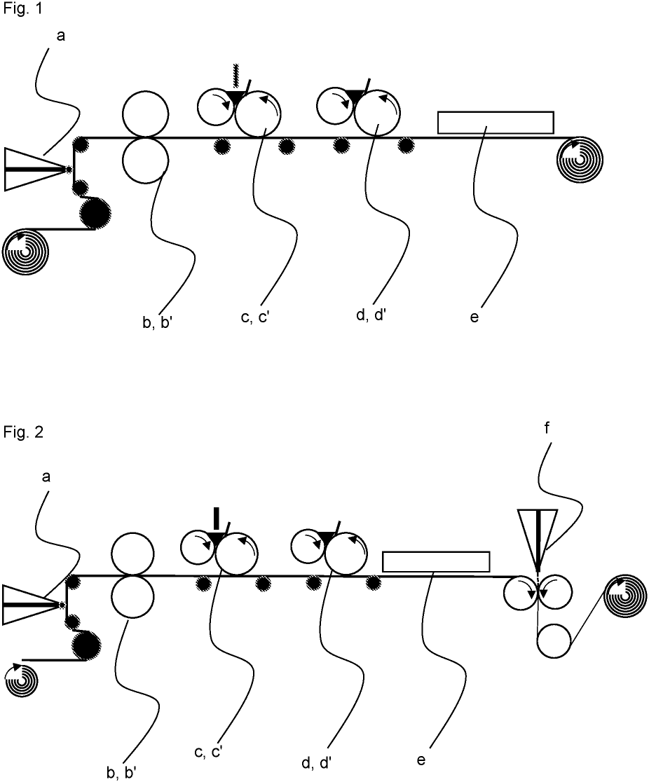

Embodiments of the method for manufacturing the UV protective film according to the invention are illustrated in FIGS. 1 to 9. For identical process sequences, the same reference signs are used for the devices shown in the figures. In all illustrated processes, a base film 1 is produced in a manner known per se (not shown), e.g. by calendering. This base film 1 is printed in an equally known manner (unless it is a coloured film for monochrome construction elements) and, if necessary, provided with a primer 5 and/or irradiated on the underside (bottom meaning facing the substrate). Usually, the base film 1 is rolled up and stored. In the next step, the printed (or dyed) base film 1 is unrolled and a reactive hot melt mass is applied to the base film 1 or the print D.

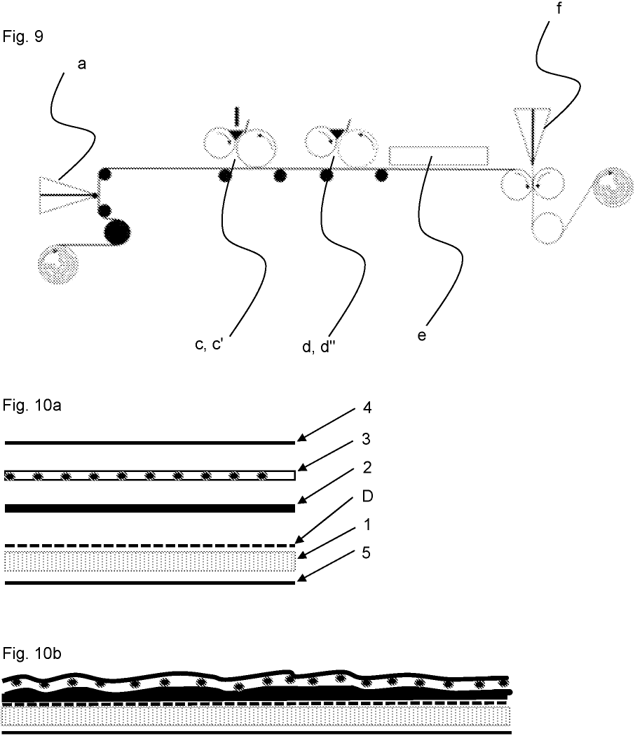

In the embodiments shown in FIGS. 1, 2, 4, 6, 8 and 9, an intermediate layer 2 without particles is first applied by means of a slot die a. In FIGS. 1, 2, 4 and 6 the intermediate layer 2 on the base film 1 is embossed with a pair of rollers b, b′. In FIGS. 8 and 9 a smooth intermediate layer is foreseen.

In all figures, an abrasion resistant polyurethane based hot melt coating with particles is applied as a second or third layer 3 by means of rollers c, c′. In FIG. 8, the roller c″ is structured, so that the structuring of the PUR hot melt coating takes place directly when the layer is applied. A separate embossing is not necessary and is preferably not carried out. After application, the heated PUR hot melt coating 3 cures by contact with atmospheric moisture. Alternatively, radiation curing can be provided for radiation-curing reactive hot melt masses.

Then, in FIGS. 1, 2, 4, 6, 8 and 9, the lacquer 4, here a UV-curing acrylic lacquer, is applied by roller application through the rollers d, d′. In FIG. 9, the roller d″ is structured so that the film is structured directly when the lacquer is applied. The lacquer 4 is cured by UV radiation from the radiation source e. The lacquer is cured e.g. by UV lamps, LED lamps; an excimer laser or excimer UV lamp may also be used to achieve a matt finish and improved scratch resistance of the surface.

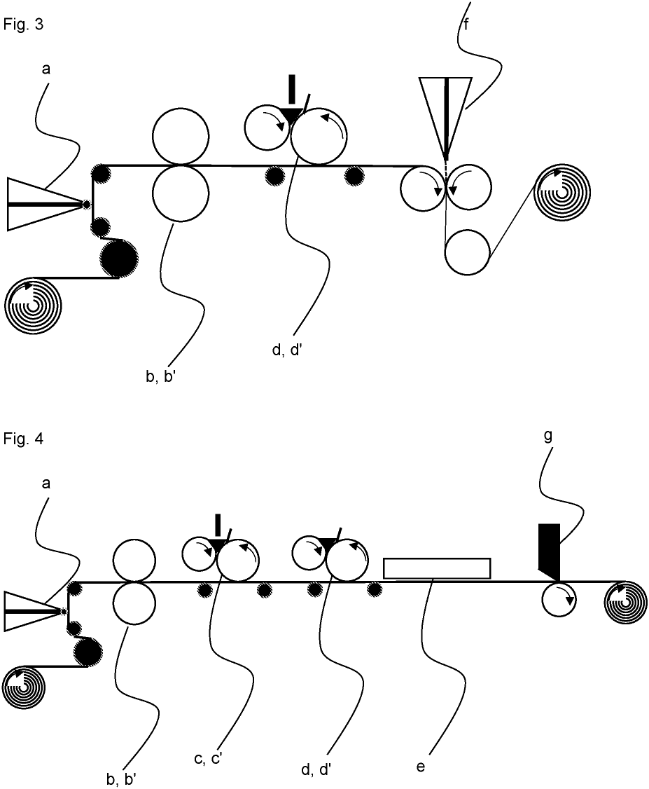

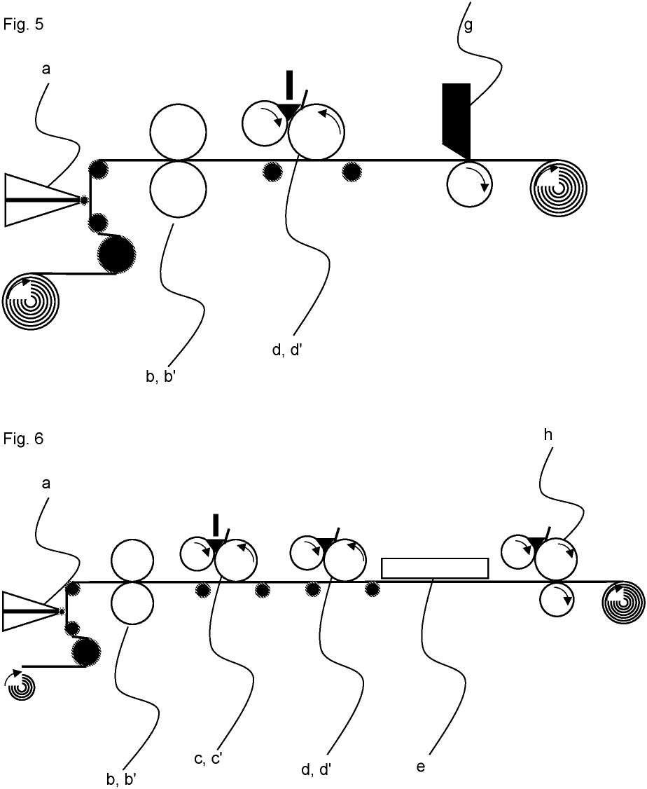

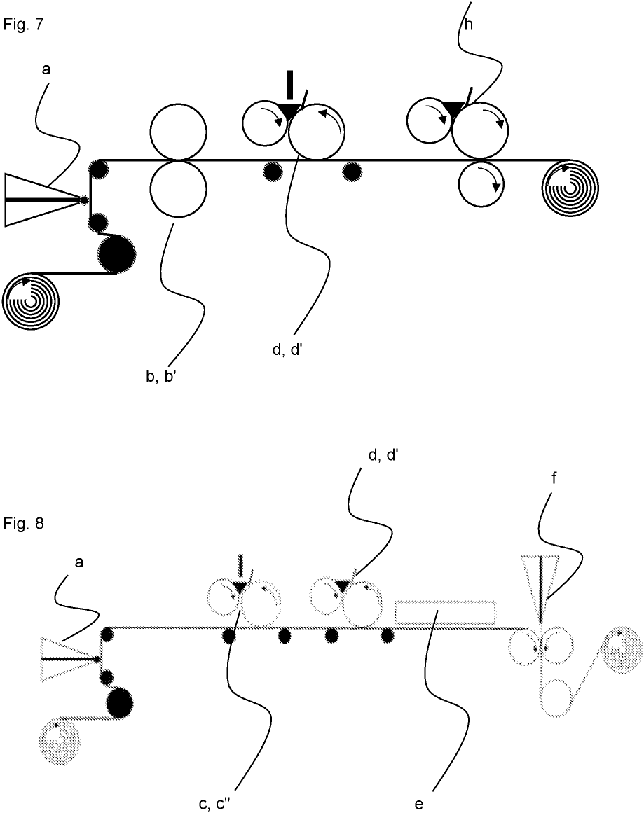

According to FIGS. 2, 8 and 9, a polymer protective layer 6 is cast onto the lacquer, coated on with a doctor blade according to FIG. 4 and rolled on according to FIG. 6. In FIG. 3, the polymer protective layer 6 is cast directly onto the PUR hot melt coating 3, in FIG. 5 it is coated on with a doctor blade and in FIG. 7 it is rolled on.

The finished UV protective film is wound up and is ready for coating substrates after the hot melt coating(s) has/have cured. It comprises an intermediate layer and a lacquer in FIGS. 1, 2, 4, 6, 8 and 9, and a polymer protective layer 6 in FIGS. 2 to 9. In FIGS. 3, 5 and 7 the lacquer 4 and the intermediate layer 2 are missing, in FIG. 1 a polymer protective layer 6.

FIGS. 10a and 10b schematically show the layers of a first preferred UV protective film separated and brought together. It can be seen here how the structuring or embossing of the intermediate layer 2 determines the surface structure of the UV protective film. PUR hot melt coating 3 and lacquer 4 follow the structure of the intermediate layer 2.

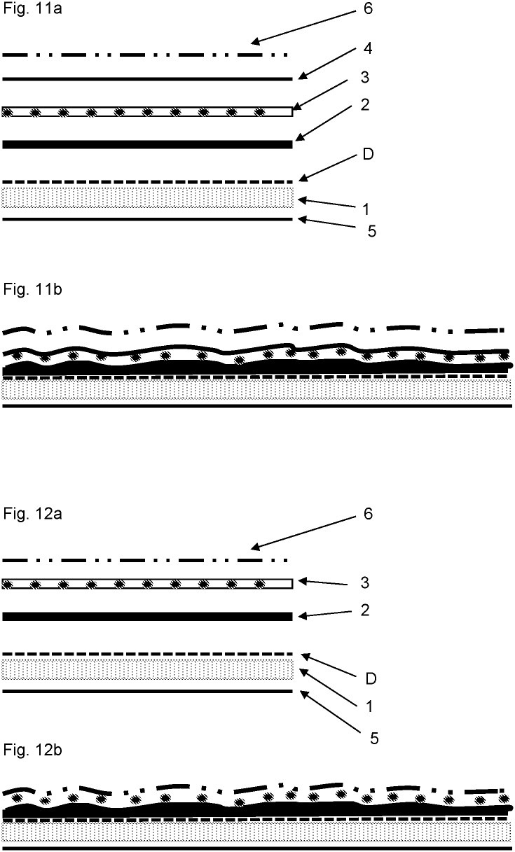

FIGS. 11a and 11b schematically show the layers of a second preferred UV protective film separated and brought together. It can be seen here how the structuring or embossing of the intermediate layer 2 determines the surface structure of the UV protective film. PUR hot melt coating 3, lacquer 4 and polymer protective layer 6 follow the structure of the intermediate layer 2.

FIGS. 12a and 12b schematically show the layers of a third preferred UV protective film separated and brought together. It can be seen here how the structuring or embossing of the intermediate layer 2 determines the surface structure of the UV protective film. PUR hot melt coating 3 and polymer protective layer 6 follow the structure of the intermediate layer 2.

The invention also relates to all combinations of preferred embodiments, as far as these are not mutually exclusive. The indications “approximately” or “about” in connection with a numerical indication mean that at least values higher or lower by 10 % or values higher or lower by 5 % and in any case values higher or lower by 1 % are included. Unless otherwise stated or the context necessarily indicates otherwise, percentages refer to the weight, in case of doubt to the total weight of the mixture.

LIST OF REFERENCE SIGNS

| | |
|---|---|
| 1 | base film |
| 2 | intermediate layer |
| 3 | PUR hot melt coating based on polyurethane |
| 4 | lacquer |
| 5 | primer |
| 6 | polymer protective layer |
| D | print |
| a | slot die with or without roller bar |
| b, b′ | pair of embossing rollers |
| c, c′ | roller application PUR hot melt coating, c, c″ with structured roller c″ |
| d, d′ | roller application of lacquer, d, d″ with structured roller d″ |
| e | radiation source |
| f | casting polymer protective layer (direct extrusion) |
| 9 | doctor blade application of polymer protective layer |
| h | roller application of polymer protective layer |

1. UV protective film comprising:
a base film of polyvinyl chloride, polyacrylate or polyolefin,
a printed design and/or colouring of the base film,
an abrasion resistant, transparent polyurethane based hot melt coating, which comprises particles with corresponding hardness, and
a lacquer and/or a polymer protective layer,, wherein an embossed, transparent intermediate layer comprising a reactive hot melt mass which contains no or fewer particles than the abrasion resistant polyurethane based hot melt coating is arranged under the abrasion resistant polyurethane based hot melt coating.

2. UV protective film according to claim 1, wherein the thickness of the intermediate layer is from 10 to 100 µm.

3. UV protective film according to claim 1, wherein the base film has a primer on the underside and/or has been subjected to plasma radiation or corona treatment.

4. UV protective film according to claim 1, wherein the base film has a thickness from 40 to 250 µm.

5. UV protective film according to claim 1, wherein the abrasion resistant hot melt coating comprises particles selected from the group consisting of glass particles, particles used as abrasives, and mixtures thereof.

6. UV protective film according to claim 1, wherein the abrasion resistant hot melt coating has a thickness of from 10 to 150 µm.

7. UV protective film according to claim 1, wherein the lacquer is an acrylate lacquer or a polyurethane lacquer.

8. UV protective film according to claim 1, wherein the lacquer has a thickness of from 1 to 50 µm.

9. Method for manufacturing of coated construction elements, wherein a UV protective film according to claim 1 is provided, a substrate is provided, and the UV protective film is laminated to the substrate.

10. Method according to claim 9, wherein the UV protective film is laminated to the substrate made of wood, metal, plastic or composite material by heat lamination or adhesive lamination.

11. Method according to claim 9, wherein the construction element is selected from the group consisting of floor boards, floor slabs, panels, fence posts, fence elements, visual protection elements, swimming pool covers and plant boxes.

12. Method for manufacturing UV protective films according to claim 1, comprising
producing a base film from PVC, polyacrylate or polyolefin and printing a design on the base film or producing a coloured base film from PVC, polyacrylate or polyolefin
applying a polyurethane based hot melt coating to the base film or printing
applying a lacquer and/or a polymer protective layer
wherein the base film and/or an intermediate layer under the hot melt coating and/or the hot melt coating is embossed.

13. Method according to claim 12, wherein the base film is printed by gravure printing or by digital printing.

14. Method according to claim 12, wherein the abrasion resistant hot melt coating is applied by brushing on, coating on with a doctor blade or roller application.

15. Method according to claim 12, wherein an embossed polyurethane based intermediate layer containing no filler or substantially less filler than the hot melt coating is introduced under the hot melt coating.

16. Method according to claim 12, wherein the embossing depths are from 5 to 30 µm.

17. Method according to claim 12, wherein the lacquer is cured by radiation and/or the polymer protective layer is applied by casting, coating with a doctor blade or roller application.

18. UV protective film comprising:
an at least 500 µm thick base film of polyvinyl chloride, polyacrylate or polyolefin,
a printed design and/or colouring of the base film,
an abrasion resistant polyurethane based hot melt coating, and
a lacquer and/or a polymer protective layer.

19. UV protective film according to claim 18, wherein a smooth or embossed intermediate layer comprising a reactive hot melt mass which contains no or fewer particles than the abrasion resistant polyurethane based hot melt coating is arranged under the abrasion resistant polyurethane based hot melt coating.

20. UV protective film according to claim 19, characterized in that the thickness of the intermediate layer is from 10 to 100 µm.

21. UV protective film according to claim 18, wherein the base film has a thickness from 1000 to 2500 µm.

22. UV protective film according to claim 18, wherein the abrasion resistant hot melt coating comprises particles selected from the group consisting of glass particles, particles used as abrasives and mixtures thereof.

23. UV protective film according to claim 18, wherein the abrasion resistant hot melt coating has a thickness of from 10 to 150 µm.

24. UV protective film according to claim 18, wherein the lacquer is an acrylate lacquer or a polyurethane lacquer.

25. UV protective film according to claim 18, wherein the lacquer has a thickness of from 1 to 50 µm or the lacquer layer providing the structuring is a thick lacquer layer allowing a structuring with a depth of 60 µm or more.

26. Method for manufacturing of coated construction elements, wherein a UV protective film according to claim 18 is provided, a substrate is provided, and the UV protective film is laminated to the substrate.

27. Method according to claim 26, wherein the UV protective film is laminated to the substrate made of concrete, screed, wood, metal, plastic or composite material by heat lamination or adhesive lamination.

28. Method according to claim 26, wherein the construction element is selected from the group consisting of screed, floor boards, floor slabs, panels, fence posts, fence elements, visual protection elements, swimming pool covers and plant boxes.

29. Method for manufacturing UV protective films according to claim 21, comprising
producing an at least 500 µm thick base film from PVC, polyacrylate or polyolefin and printing a design on the base film or producing a coloured base film from PVC, polyacrylate or polyolefin
applying a polyurethane based hot melt coating to the base film or printing
applying a lacquer and/or a polymer protective layer
wherein the base film and/or an intermediate layer under the hot melt coating and/or the hot melt coating and/or the lacquer is structured or embossed.

30. Method according to claim 29, wherein the base film is printed by gravure printing or by digital printing.

31. Method according to claim 29, wherein the abrasion resistant hot melt coating is applied by brushing on, coating on with a doctor blade or roller application with a pair of rollers in which one roller is structured.

32. Method according to claim 29, wherein a smooth or structured polyurethane based intermediate layer containing no filler or substantially less filler than the hot melt coating is introduced under the hot melt coating.

33. Method according to claim 29, wherein the depth of the structuring or the embossing depths are from 5 to 30 µm or the lacquer layer providing the structuring is a thick lacquer layer allowing a structuring with a depth of 60 µm or more.

34. Method according to claim 29, wherein the lacquer is cured by radiation and/or the polymer protective layer is applied by casting, coating with a doctor blade or roller application.

35. Method of manufacturing a UV protective film comprising the steps of:
providing a base film of polyvinyl chloride, polyacrylate or polyolefin having a printed design and/or coloring of the base film,
applying an abrasion resistant polyurethane based hot melt coating above the base film, and
applying a lacquer and/or a polymer protective layer above the abrasion-resistant hot melt coating,
wherein the abrasion resistant polyurethane based hot melt coating and/or the lacquer and/or an applied intermediate layer of a reactive polyurethane based hot melt mass is structured by the application being effected by a pair of rollers with a structured roller.

36. Method according to claim 35, wherein an embossed intermediate layer comprising a polyurethane based reactive hot melt mass which contains no or fewer particles than the abrasion resistant polyurethane based hot melt coating is applied above the base film and below the abrasion resistant polyurethane based hot melt coating.

37. Method according to claim 35, wherein the application of the reactive hot melt mass is carried out in such an amount that the thickness of the intermediate layer is from 10 to 100 µm.

38. Method according to claim 35, wherein the base film is provided with a thickness of from 40 to 450 µm.

39. Method according to claim 35, wherein the abrasion resistant hot melt coating comprises particles selected from the group consisiting of glass particles, particles used as abrasives and mixtures thereof.

40. Method according to claim 35, wherein the abrasion resistant hot melt coating is applied in such an amount that it has a thickness of from 10 to 150 µm.

41. Method according to claim 35, wherein the lacquer is an acrylate lacquer or a polyurethane lacquer.

42. Method according to claim 35, wherein the lacquer is applied in such an amount that it has a thickness of from 1 to 50 µm.

43. Method according to claim 35, wherein the base film has been printed by gravure printing or by digital printing.

44. Method according to claim 35, wherein the abrasion resistant hot melt coating is applied by brushing on, doctoring or roller application with one of the rollers being structured.

45. Method according to claim 36, wherein the intermediate layer of reactive hot melt mass is introduced under the abrasion resistant hot melt coating.

46. Method according to claim 35, wherein depths of the structuring introduced with the structured roller are from 5 to 30 µm.

47. Method according to claim 35, wherein the lacquer is cured by radiation and/or the polymer protective layer is applied by casting, doctoring or roller application.

48. Method for manufacturing coated construction elements, wherein a UV protective film manufactured according claim 35 is provided, a substrate is provided, and the UV protective film is laminated to the substrate.

49. Method according to claim 48, wherein the UV protective film is laminated to the substrate made of wood, metal, plastic or composite material by heat lamination or adhesive lamination.

50. Method according to claim 48, wherein the construction element is selected from the group consisting of floor boards, floor panels, panels, fence posts, fence elements, privacy screen elements, swimming pool covers and plant boxes.

51. UV protective film comprising
a base film of PVC, polyacrylate or polyolefin,
a printed design and/or a coloring of the base film,
a smooth intermediate layer comprising a first polyurethane based hot melt coating
a layer comprising an abrasion resistant, second polyurethane based hot melt coating
a lacquer and/or a polymer protective layer
wherein the abrasion resistant second melt coating and/or the lacquer is structured.

52. UV protective film according to claim 51, wherein the first hot melt coating contains no or fewer particles than the abrasion resistant second hot melt coating.
